(19) United States
(12) Patent Application Publication
(10) Pub. No.: US 2008/0207480 A1
(43) Pub. Date: Aug. 28, 2008

(54) Soaps From Organic Residues And Method Of Producing Same

(76) Inventor: Gregory Pipko, Katzrin (IL)

Correspondence Address: SCHWEITZER CORNMAN GROSS & BONDELL LLP, 292 MADISON AVENUE - 19th FLOOR, NEW YORK, NY, 10017, US

(21) Appl. No.: 11/908,889

(22) PCT Filed: Mar. 15, 2006
(86) PCT No.: PCT/IL06/00338

§ 371 Date: Sep. 17, 2007

(30) Foreign Application Priority Data
Mar. 17, 2005 (IL) 167500

(51) Int. Cl. C11D 13/00

(52) U.S. Cl. 510/491

(57) ABSTRACT

The present invention discloses soap obtained by dispersing synthetic and/or natural soap and liquid organic residues by hydrolyzing at least one natural oil so as water-soluble soap is obtained; and dispersing organic residues in a water miscible solution until a homogeneous soap composition phase is obtained and a method of producing such soaps from organic residues.

### FIELD OF THE INVENTION

The present invention generally relates to soaps obtained from organic residues and to a method of producing such soaps.

### BACKGROUND OF THE INVENTION

Soap was made by mixing animal fats with lye, such as ashes of a wood fire. In modern times, many of the soaps are mixtures of sodium or potassium salts of fatty acids which can be derived from oils or fats by reacting them with an alkali such as sodium or potassium hydroxide at elevated temperatures.

Vegetable oil, as such as olive oil, is produced by pressing it out of oil-bearing seeds, usually by hydraulic power presses. The residual product is a dense cake of crushed and compressed seed husks. This dense slab is provided in some extent for animal feed wherein most of it is decomposed or regarded as either costless or valuable agricultural effluent.

U.S. Pat. No. 4,483,742 to Bridle discloses liquid soaps for use in paper re-cycling and other industrial cleaning or scouring processes. The liquid soap comprises an aqueous partially saponified mixture comprising 1 part of pine oil (a mixture of terpene alcohols and hydrocarbons) and from 1 to 20 parts of a soap-making fatty acid, such as tall oil or distilled oil. The mixture is preferably saponified by use of 30% sodium hydroxide solution. The liquid soap may contain less than 10% water.

U.S. Pat. No. 6,380,153 to Carlson discloses methods of producing surfactant compositions are disclosed in which processed plant material is used to enhance the saponification process to produce surfactant compositions having enhanced surfactant, mechanical cleaning and emollient characteristics. The plant material provides additional oils and triglycerides for reaction in the saponification process and provides an improved reaction interface, thereby producing surfactant compositions of improved character.

U.S. Pat. No. 6,020,509 to Weerasooriya discloses a process for producing a surfactant composition by partially saponifying an alkoxylated triglyceride having the formula: comprising an alkali metal hydroxide such as sodium hydroxide and recovering a surfactant composition comprising soap and moisturizing agents comprised of alkoxylated monoglycerides and unreacted alkoxylated triglycerides. Hence, a soap made of said dense slab or ‘cake’ of crushed and compressed seed husks is still a long felt need.

### SUMMARY OF THE INVENTION

It is one object thus of the present invention to provide a novel method of producing soaps from organic residues. This method comprising hydrolyzing one or more natural oils so as water-soluble soap is obtained and dispersing organic residues in a water miscible solution until a homogeneous soap composition phase is obtained. Preferably, said method further comprises steps of admixing preservatives, additives, fillers etc.

It is another object of the present invention to provide soap, wherein said soap is obtained by dispersing synthetic and/or natural soap and liquid organic residues by hydrolyzing at least one natural oil so as water-soluble soap is obtained; and dispersing organic residues in a water miscible solution until a homogeneous soap composition phase is obtained. The soap is preferably comprising ingredients selected from preservatives, additives, fillers etc.

More particularly, the present invention provide a environmental friendly and cost effective means of recycling dense cake of crushed and compressed seed husks, in the manner that natural or at least partially natural soaps are obtained.

### DETAILED DESCRIPTION OF THE PREFERRED EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. Further modifications will remain apparent to those skilled in the art, since the generic principles of the present invention have been defined specifically to provide a method of producing soaps from organic residues and soaps obtained by dispersing synthetic and/or natural soap and liquid organic residues to form a soap product.

The term ‘soap’ refers hereinafter to any soap, detergent, surface-active agents, surfactants, rinsing agents and to any cleansing agents used for personal or minor cleaning. The term is related to either soaps in solid moulded or solid provided in a pellet form, or a liquid (flowing) soap. Said soap is referring to any type of soap, including, yet not limited to shampoo, body or hand-cleansing composition, toothpaste or any other soap form used for human or veterinary hygiene, utilized in industrial applications, applicable for laundry cleaning etc.

The term ‘organic residues’ refers hereinafter to organic biomass, residual product which is a dense slab or ‘cake’ of crushed and/or compressed seed husks; and especially to olive, olive see, olive tree, olive leaf extracts, products and by-products.

The method according to the preset invention is an improvement of traditional methods that were historically enveloped with olive press. It is known in the art that an olive press works by applying pressure to olive paste to separate the liquid oil and vegetation water from the solid material. The oil and vegetation water are then separated by standard decantation. This method is still widely used today, and it's still a valid way of producing high quality olive oil if adequate precautions are taken. First the olives are ground into an olive paste, using large grindstones. The olive paste generally stays under the stones for about half an hour, this has three objectives, namely to guarantee that the olives are well ground, to allow enough time for the olive drops to join to form the largest droplets of oil and to allow the fruit enzymes to produce some of the oil aromas and taste. Rarely, olive oil mills use a modern crushing method with a traditional press. After grinding, the olive paste is spread on fiber disks, which are stacked on top of each other, then placed into the press. Traditionally the disks were made of hemp or coconut fiber, but nowadays they're made of synthetic fibers which are easier to clean and maintain. These disks are then put on a hydraulic piston, forming a pile. Pressure is applied on the disks, thus compacting the solid phase of the olive paste and percolating the liquid phases (oil and vegetation water). The applied hydraulic pressure can go to 400 atm. To facilitate separation of the liquid phases, water is run down the sides of the disks to increase the speed of percolation. The liquids are then separated either by a standard process of decantation or by the means of a faster vertical centrifuge. The traditional method is a valid form of producing high quality olive oil, if after each extraction the disks are properly cleaned from the remains of paste; if not the leftover paste will begin to ferment thereby producing inconsistencies of flavours (called defects) that will contaminate the subsequently produced olive oil. A similar problem can affect the grindstones, that in order to assure perfect quality, also require cleaning after each usage.

The present invention overcomes drawbacks of traditional process, such as difficult cleaning, non-continuous process introducing waiting periods thus exposing the olive paste to the action of oxygen and light, requirement for extensive manual labor and longer time period from harvest to pressing.

Some aspects of the invention utilizes methods of olive oil extraction uses an industrial decanter, e.g., decanter centrifugation, to separate all the phases by centrifugation. In this method the olives are crushed by the use of a rotating mechanical mill that grinds the olives in to a fine paste. This paste is then malaxed for 30 to 40 min in order allow the small olive droplets to agglomerate. The aromas are created in these two steps through the action of fruit enzymes. Afterwards the paste is pumped in to an industrial decanter where the phases will be separated. To facilitate the extraction process with the paste there is a certain quantity of water added. The decanter is a large capacity horizontal centrifuge rotating around 3000 rpm, the high centrifugal force created allows the phases to be readily separated according to their different densities (solids>vegetation water>oil). Inside the decanters rotating conical drum there is a coil that rotates a few rpm slower, pushing the solid materials out of the system. The three phases are separated according to their densities. The separated oil and vegetation water are then rerun trough a vertical centrifuge, working around 6000 rpm that will separate the small quantity of vegetation water still contained in oil and vice versa.

Various industrial decanters are applicable in this invention. With the standard three phases oil decanter, a portion of the oil polyphenols is washed out due to the higher quantity of added water (when compared to the traditional method), producing a larger quantity of vegetation water that needs to be processed. The two phases oil decanter was created as an attempt to solve these problems. Sacrificing part of its extraction capability, it uses less added water thus reducing the phenol washing. The olive paste is separated into two phases: oil and wet pomace. This type of decanter, instead of having three exits (oil, water and solids), has only two. The water is expelled by the decanter coil together with the pomace, resulting in a wetter pomace that is much harder to process industrially. Many pomace oil extraction facilities refuse to work with these materials because the energy costs of drying the pomace for the hexane oil extraction often make the extraction process sub-economical. In practice, then, the two phases decanter solves the phenol washing problem but increases the residue management problem.

The present invention also overcomes various disadvantages of the modern process, namely: the process of the present invention is respectfully inexpensive, less technical labor required, it requires low energy consumption, pomace is utilized and re-used, lesser amount of vegetable water is to be disposed of etc.

Hence, a novel method of producing soaps from organic residues is hereto disclosed. This method comprising the steps of hydrolyzing at least one natural oil so as water-soluble soap is obtained and dispersing organic residues in a water miscible solution until a homogeneous soap composition phase is obtained.

It is according to one embodiment of the present invention wherein the hydrolyzing is provided in basic conditions, e.g., at pH ranging from about 7.5 to 12.5.

It is according to another embodiment of the present invention wherein the above-mentioned method additionally comprising admixing of glycerol.

It is according to another embodiment of the present invention wherein the organic residues are selected from olive oil, olive products, olive tree products, olive oil production residuals, wine production residues, fruit or vegetable residues, canned food industries or any combination thereof.

It is according to another embodiment of the present invention wherein the water-soluble soap is at least partially displaced by one or more synthetic surface-active agents.

It is according to another embodiment of the present invention wherein the synthetic surface-active agents are selected from sulfonates, such as dodecyl benzene sulfonate and its derivatives; alkyl sulfate anionic surfactants; laurates, such as sodium laurate, sodium lauryl sulfates; ethanolamines, such as ethanolamine lauryl sulfate; polyethanolmides and mixture of ethanolamides of lauric acid or any mixture thereof.

Synthetic surface-active agents as defined above may be selected from anionic surfactants, such as alkyl benzene sulfonates, or sulfonates comprising potassium, sodium, ammonium, hydrogen or the like: sodium dodecyl benzene sulfonate and sodium tridecyl benzene sulfonate, commercially available surfactants selected from “Ardet” AB-40 (sodium dodecyl sulfonate), “Conco” AAS-50S (ammonium dodecyl benzene sulfonate), “Conco” ATR-98S (hydrogen tridecyl benzene sulfonate), “Memkal” NOBS (sodium nonyl benzene sulfonate), “Sole-Fonate” 102 (calcium dodecyl benzene sulfonate) etc. Other anionic surfactants comprising alkyl phosphates, and alkyl sulphosuccinates e.g., sodium dioctyl sulphosuccinate and sodium di(tertiary)nonyl sulphosuccinate. Examples of alkyl sulphosuccinates are the octyl and nonyl ester type. Other anionic surfactants are selected from secondary alkyl sulfate type, monoglyceride sulfate, isethionates, acyl sarcosines, and its derivatives. Amphoteric surfactants are potentially useful for the present invention and selected from coco amido alkyl betaine, acyl peptides and acyl amino acids.

Alkyl sulfate anionic surfactants, are preferably those derived from lauryl and myristyl alcohols, and its derivatives, such as alkyl polyethylene glycol sulfates (alkyl ether sulfates), e.g., lauryl polyethylene glycol sulfate.

Ethanolamines are selected according to one preferred embodiment of the present invention monoethanolamine (MEA), diethanolamine (DEA) and triethanolamine (TEA) It is according to another embodiment of the present invention wherein the synthetic surface-active agents are selected from anionic surfactants, especially those derived from lauryl and myristyl alcohols

It is according to another embodiment of the present invention wherein said method additionally comprising admixing of preservatives. It is acknowledged in this respect that the preservatives are preferably, yet not exclusively selected from biocides, bactericides or fungicides.

Hence, it is according to another embodiment of the present invention wherein said method additionally comprising at least one step of admixing boric acid and/or borates; said borates are preferably selected from sodium, potassium, magnesium, calcium, barium manganese, ferrous borates or any combination thereof.

Hence, it is according to another embodiment of the present invention wherein said preservatives comprising etheric oils. The etheric oils are preferably obtained form fruits or vegetables selected from linen blossoms (etheric oils with quercitin and farnesol) St. Johns wort oil (for example, olive oil extracts) calendula, arnica (for example oily extracts of blossoms with etheric oils, polar extracts with flavonoid lemon balm (for example flavone and etheric oils), sage (for example etheric oils with thymol) niseseed (etheric oils with trans-anethol), carnation oil (for example etheric oil with eugenol), camomile (camazulene, alpha-bisabolol, myrtols, (limonine, alpha-pinene, cineol), peppermint oil (for example, oil with menthol) caraway seed (for example, oil with carvone) larch (for example oil with alpha-pinene) Juniper, rosemarin, eucalyptus oil, lavender, fir needle oil, bergamo oil, citrus oil, lemon balm, marjoram, thyme, basil (stomatica or herbs) and fennel.

Hence, it is according to another embodiment of the present invention wherein said preservatives selected from methyl- and/or propyl-paraben.

More specifically, the aforesaid etheric oils are obtained from fruits and vegetables, selected from sage, Rosemarie, lemon, bergamot, tea tree, mint, pine, sandalwood, patchouli, lemon grass, peppermint, grapefruit, oridanium, manuka, eucalyptus, geranium, clove, cinnamon, Melissa or any combination thereof.

It is according to another embodiment of the present invention wherein the disclosed method additionally comprising admixing additives. The additives are preferably, yet not exclusively, selected from perfuming agents, stabilizers, thickfires, emulsifiers, vitamins, radical scavengers, conditioners, antioxidants, lipophilic or hydrophilic plant extracts or any combination thereof.

It is according to another embodiment of the present invention wherein the hereto defined method additionally comprising admixing fillers for viscosity regulation.

The fillers or viscosity regulators are preferably selected from calcium carbonate, talc, dolomite, perlyte, magnesium carbonate or a mixture thereof.

It is according to another embodiment of the present invention wherein water-soluble soap is obtained by hydrolyzing fats selected from vegetable oil, tallow, animal fats, cod liver oil, with sodium hydroxide or potassium hydroxide. Said method may further comprise at least one step of admixing the obtained soap without separating the biomass with etheric oil.

Vegetable oil may comprised of immuno stimulants: echinacea purpuria (alcoholic extracts, fresh plant juice, pressed juice), elutheriococcus genticosus; alkaloids: rauwolfia, (for example, prajmaline evergreen, (for example vincamine); and phytopharmaceuticals, such as aloe, horse chestnuts (for example aescin), garlic (for example, garlic oil), pineapple (for example, bromelaein) ginseng (for example, ginsenoside), marythistle fruit (for example, extracts standardized on silbmarin), mouse thorn root (for example ruscogenine), valeriana (for example valepotriate, and tincture valerainae nigh), Kava Kava (for example Cavalactone), hop blossom (hop bitters), extract of passiflorae, gentian (for example ethanol extract), anthraquinone containing drug extracts, (for example, aloin containing aloe vera juice), pollen extract, algin extract, liquorice extract, palm extract, galphimia (for example, prototincture), mistletoe, (for example, aqueous ethanol extract), phytosterols (for example, beta-sitosterine), verbascom (aqueous alcohol extract), droseria (liquor wine extract), sandthorn fruit, (for example the juice thereof), marshmallow root, primula root extract, fresh plant extracts of mellow, comfrey, ivy, Schachtelhalm, Yarrpwe, ribwart (for example pressed juice) nettles, celandine, parsley.

Alternatively or additionally, the aforesaid method additionally comprising a step of reacting sodium or potassium hydroxide with oleic acid, tall oils, stearic or a combination thereof.

It is according to another embodiment of the present invention to disclose a novel and cost effective soap, wherein said soap is obtained by dispersing synthetic and/or natural soap and liquid organic residues.

It is according to another embodiment of the present invention wherein the soap additionally comprising fillers. The fillers or viscosity regulators are preferably selected from calcium carbonate, talc, dolomite, perlyte, magnesium carbonate or a mixture thereof.

It is according to another embodiment of the present invention wherein the soap additionally comprising preservatives.

It is according to another embodiment of the present invention wherein the preservatives are selected from boric acid and/or borates. The borates are preferably selected from sodium, potassium, magnesium, calcium, barium manganese, ferrous borates or any combination thereof. The concentration of the borate-containing compositions is varied from about 0.1% to 5.0%; and preferably from about 0.15% to 0.5% (weight percent).

It is according to another embodiment of the present invention wherein the preservatives are selected from biocides, bactericides or fungicides. The preservatives may comprise etheric oils. The etheric oils are preferably but not exclusively obtained form fruits or vegetables selected from linen blossoms (etheric oils with quercitin and farnesol) St. Johns wort oil (for example, olive oil extracts) calendula, arnica (for example oily extracts of blossoms with etheric oils, polar extracts with flavonoid lemon balm (for example flavone and etheric oils), sage (for example etheric oils with thymol) niseseed (etheric oils with trans-anethol), carnation oil (for example etheric oil with eugenol), camomile (camazulene, alpha-bisabolol, myrtols, (limonine, alpha-pinene, cineol), peppermint oil (for example, oil with menthol) caraway seed (for example, oil with carvone) larch (for example oil with alpha-pinene) Juniper, rosemary, eucalyptus oil, lavender, fir needle oil, bergamot oil, citrus oil, lemon balm, marjoram, thyme, basil (stomatica or herbs) and fennel.

It is according to another embodiment of the present invention wherein the preservatives are selected from methyl- and/or propyl-paraben.

It is well in the scope of the present invention wherein the etheric oils are obtained from fruits and vegetables selected from sage, Rosemarie, lemon, bergamot, tea tree, mint, pine, sandalwood, patchouli, lemon grass, peppermint, grapefruit, oridanium, manuka, eucalyptus, geranium, clove, cinnamon, Melissa or a combination thereof. The concentration of etheric oils is preferably ranging from about 0.1 to 5.0% (weight percent).

It is according to another embodiment of the present invention wherein the soap as defined in any of the above additionally comprising additives, and/or it is additionally comprised natural soaps and/or glycerol.

It is according to another embodiment of the present invention wherein the organic residues are obtained from oil cake mill. The oil obtained from the oil cake mill is preferably selected from olive oil, Soya oil, linseed oil, sunflower oil or a mixture thereof. Still preferably, the soap is additionally comprised of water immiscible and/or water miscible process products or by-products obtained from the oil cake milling. The products obtained from the oil cake milling are preferably, and according to yet another embodiment of the present invention, ingredients of crushed seeds, especially olive crushed pips or seeds. Hence, organic residues are alternatively obtained from organic residues of juice production or wood flow.

It is according to another embodiment of the present invention wherein the method of producing olive soap as defined in any of the above comprises steps selected in anon-limiting manner from:
a. cleansing olives, e.g., rinsing it with water;
b. grinding or crushing the olives to paste;
c. mixing to increase olive oil yield;
d. separating or decanting the oil and water from pomace;
e. separating a the oil from polyphenols rich water and optionally recycling the same;
f. hydrolyzing said oil so as water soluble soap is obtained; and,
g. dispersing said pomace organic residues in a water miscible solution until a homogeneous soap composition phase is obtained.

It is according to another embodiment of the present invention wherein the method further comprising step or steps of removing at least a portion of the pits from the olive flash before the olives are grinded to paste so as a pits-free olive oil is obtained. The term pits-free olive oil refers to an olive oil free of pits' fragments and form pits' ingredients.

It is according to another embodiment of the present invention wherein the method further comprising step or steps of removing at least a portion of the pits from the olive flash before the olives are grinded to paste and admixing said pits with the pomace.

It is according to another embodiment of the present invention wherein the method further comprising step or steps of removing at least a portion of the pits from the olive flash before the olives are grinded to paste and admixing the pits with the obtained soap.

It is according to another embodiment of the present invention wherein the method further comprising step or steps of admixing said polyphenols rich waters with the soap until a homogeneous soap composition phase is obtained.

It is according to another embodiment of the present invention wherein the method further comprising step or steps of admixing said etheric oils with the soap until a homogeneous soap composition phase is obtained.

It is according to another embodiment of the present invention wherein the step or steps of separating of the oil and water from pomace is provided by either a tri-phases decanter or a two-phases decanter.

It is according to another embodiment of the present invention wherein the grinding the olives to paste is provided by a disc-grinder.

It is according to another embodiment of the present invention wherein the method additionally comprising applying an oxygen-free environment in at least a portion of said steps.

It is according to another embodiment of the present invention wherein a pits-free olive oil is provided. The oil is characterized by being free of pits' fragments and of pits' ingredients and oils

In order to understand the invention and to see how it may be implemented in practice, a plurality of examples will now be described, by way of non-limiting example only, with reference to the accompanying drawing, in which glycerol (15 g) was admixed with stearine (150 g) at 75 C until the stearine dissolved. ETA (40 g) is further admixed by a means of a homogenizer. A water solution of Na₂B₄O₇ (50 g, 0.3%) is admixed with sodium hydroxide. The glycerol-stearine solution homogenized with E-70. Olive seed pressing product (200 g) was further admixed with effective measure of a mixture of pine oil and clove oil. After cooling, good gelatinous soap was obtained.

Furthermore, soap was produced hydrolyzing at least one natural oil so as water soluble soap is obtained; dispersing organic residues in a water miscible solution until a homogeneous soap composition phase is obtained. Said soap comprising water 150 g, NaOH 3.5 g, Borax 0.2% 0.3 g, stearin 20 g, ETA-70 20 g, glycin 60 g, dense cake of crushed and compressed olive seed husks 250 g, tea tree oil 1.25 g, lemon grass 1.25 g and magnesium carbonate 110 g.

Another soap was produced in a method according to the present invention, and comprising water 150 g, NaOH 3.5 g, lauramide 2 g, Borax 0.2% 0.3 g, stearin 20 g, ETA-70 18 g, glycin 60 g, dense cake of crushed and compressed olive seed husks 290 g, tea tree oil 1.45 g, cinnamon oil 1.45 g and perlite 90 g.

A liquid soap was further produced in a method according to the present invention, and comprising water 15 g, olive oil 15 g, coconut oil 5 g, lauramide 5 g, potassium hydroxide 5.45 g, pine oil 2 g, orange oil 3 g, soy oil wash 50 g, dolomite 40 g.

Another soap was produced in a method according to the present invention, and comprising water 300 g, NaOH 7.1 g, lauramide 38 g, Borax 0.2% 0.3 g, glycerin 60 g, stearic acid 38 g, ETA-70 18 g, glycin 60 g, dense cake of crushed and compressed olive seed husks 440 g, pine oil 8.8 g, clove oil 2.68 g, and talc 80 g.

Another soap was produced in a method according to the present invention, and comprising water 150 g, NaOH 3.5 g, lauramide 38 g, Borax 0.2% 3 g, stearin 20 g, ETA-70 20 g, glycerin 60 g, dense cake of crushed and compressed olive seed husks 250 g, lemon grass 1.25 g, perlite 50 g.

Another soap was produced in a method according to the present invention, and comprising water 150 g, NaOH 3.5 g-3.7 g, lauramide 2-2.5 g, Borax 0.2% 0.3 g, stearin 19-25 g, ETA-70 19-25 g, glycerin 250-500 g, dense cake of crushed and compressed olive seed husks 250 g, tea tree oil 1.25-2.5 g, lemon grass 1.25-2.5 g, calcoim carbonate 30 g.

1-51. (canceled)

52. A method of producing soaps from organic residues, comprising:
a. hydrolyzing at least one natural oil, such that a water soluble soap is obtained; and,
b. dispersing organic residues in a water miscible solution of the water soluble soap until a homogeneous soap composition phase is obtained.

53. The method according to claim 52, wherein the hydrolysis is performed under basic conditions.

54. The method according to claim 52, additionally comprising admixing of glycerol with the water soluble soap.

55. The method according to claim 52, wherein the organic residues are selected from olive oil, olive products, olive tree products, olive oil production residues, wine production residues, fruit or vegetable residues, canned food industries or a combination thereof.

56. The method according to claim 52, further comprising the steps of (i) selecting a synthetic surface-active agent from a group consisting of sulfonates, laurates, ethanolamines, mixtures of ethanolamides of lauric acid, or any mixture thereof; and (ii) displacing at least a portion of said water-soluble soap with by one or more synthetic surface-active agents; and (???)

57. The method according to claim 52, additionally comprising the step of admixing boric acid and/or borates; said borates are preferably selected from a group consisting of sodium, potassium, magnesium, calcium, barium manganese, ferrous borates or any combination thereof.

58. The method according to claim 52, additionally comprising the steps of (i) selecting the natural oil from a plant oil group consisting of sage, lemon, bergamot, tea tree, mint, pine, sandalwood, patchouli, lemon grass, peppermint, grapefruit, oridanium, manuka, eucalyptus, geranium, clove, cinnamon, melissa, linen blossoms, St. Johns wort oil, calendula, arnica, sage, anise seed, carnation oil, chamomile, peppermint oil caraway seed, larch, Juniper, rosemary, eucalyptus oil, lavender, fir needle oil, bergamot oil, citrus oil, lemon balm, marjoram, thyme, basil, and fennel; and (ii) admixing the same.

59. The method according to claim 52, additionally comprising the steps of (i) selecting at least one additive from a group consisting of perfuming agents, stabilizers, thickeners, emulsifiers, vitamins, radical scavengers, conditioners, antioxidants, and lipophilic and hydrophilic plant extracts; and (ii) admixing the additives to the water miscible solution.

60. The method according to claim 52, wherein said hydrolyzing step comprises hydrolyzing an oil from a group consisting of vegetable oil, tallow, animal fats, cod liver oil, and glycerin with sodium hydroxide or potassium hydroxide.

61. The method according to claim 52, additionally comprising the step of reacting sodium or potassium hydroxide with one or more of a group consisting of oleic acid, tall oils, stearic acid, and stearin.

62. A method of producing olive soap according to claim 1, comprising steps of cleansing olives:
grinding the olives to a paste
mixing the paste to increase olive oil yield;
separating the oil and water in the paste from pomice;
separating the oil from polyphenols-rich water;
hydrolyzing the oil such that a water soluble soap is obtained; and
dispersing pomace organic residues in a water miscible solution of the water soluable soap until a homogeneous soap composition phase is obtained.

63. The method according to claim 62, further comprising the step of removing at least a portion of pits from an olive flash before the olives are ground to paste such that a pits-free olive oil is obtained.

64. The method according to claim 62, comprising the step of removing at least a portion of pits from an olive flash before the olives are ground admixing said pits with the pomace.

65. The method according to claim 62, comprising the step of removing at least a portion of pits from an olive flash before the olives are ground to paste and admixing said pits with the obtained soap.

66. The method according to claim 62, comprising the step of admixing said polyphenols rich waters with said soap until a homogeneous soap composition phase is obtained

67. The method according to claim 62, additionally comprising the step of admixing etheric oils with said soap until a homogeneous soap composition phase is obtained.

68. The method according to claim 62, additionally comprising the step of applying an oxygen-free environment in at least a portion of said steps.

69. A soap obtained by a method of dispersing synthetic and/or natural soap and liquid organic residues by hydrolyzing at least one natural oil such that water-soluble soap is obtained; preparing a water miscible solution of the water-soluble soap, and dispersing organic residues in the water miscible solution.

70. The soap according to claim 69, wherein the method of production comprises the steps of cleansing olives; grinding the olives to paste; mixing the paste to increase olive oil yield; separating the oil and water from pomace; separating the oil from polyphenols rich water; hydrolyzing said oil such that a water soluble soap is obtained; and, dispersing said pomace organic residues in a water miscible solution of the water soluble soap until a homogeneous soap composition phase is obtained.

71. The soap according to claim 69, additionally comprising fillers, especially wherein said fillers are selected from a group consisting of potassium or calcium carbonate, talc, dolomite, perlyte and magnesium carbonate.

72. The soap according to claim 69, additionally comprising preservatives; especially borates selected from a group consisting of sodium, potassium, magnesium, calcium, barium manganese, and ferrous borates; the concentration of said borates being between from 0.1% to 5.0%, and especially between 0.15% to 0.5%.

73. The soap according to claim 69 additionally comprising etheric oils in 0.1 to 5.0% (weight percent), and especially etheric oils obtained form fruits or vegetables selected from a group consisting of sage, lemon, bergamot, tea tree, mint, pine, sandalwood, patchouli, lemon grass, peppermint, grapefruit, oridanium, manuka, eucalyptus, geranium, clove, cinnamon, melissa, linen blossoms St. Johns wort oil, calendula, arnica, sage, anise seed, carnation oil, chamomile, peppermint oil caraway seed, larch, Juniper, rosemary, eucalyptus oil, lavender, fir needle oil, bergamot oil, citrus oil, lemon balm, marjoram, thyme, basil, and fennel.

74. The soap according to claim 69, additionally comprising additives selected from a group consisting of natural soaps, glycerol, methyl paraben and propyl paraben

75. The soap according to claim 69, wherein said organic residues are products of oil cake mill, especially oil cake mill selected from a group consisting of olive oil, soya oil, linseed oil, sunflower oil or a mixture thereof.

76. The soap according to claim 69, additionally comprising products selected from a group consisting of oil cake milling products, especially crushed seeds, and particularly olive crushed pips or seeds; residues of juice production or wood flow; and pits-free olive oil characterized by being free of pit fragments and pit ingredients and oils.
